(19) United States
(12) Patent Application Publication
(10) Pub. No.: US 2025/0054705 A1
(43) Pub. Date: Feb. 13, 2025

(54) CAPACITOR

(71) Applicant: Murata Manufacturing Co., Ltd., Nagaokakyo-shi (JP)

(72) Inventor: Akitomo TAKAHASHI, Nagaokakyo-shi (JP)

(21) Appl. No.: 18/931,804

(22) Filed: Oct. 30, 2024

Related U.S. Application Data
(63) Continuation of application No. PCT/JP2023/013955, filed on Apr. 4, 2023.

(30) Foreign Application Priority Data
May 13, 2022 (JP) 2022-079550

(51) Int. Cl. H01G 9/012; H01G 9/048; H01G 9/07; H01G 9/10; H01G 9/15

(52) U.S. Cl. CPC H01G 9/012; H01G 9/048; H01G 9/07; H01G 9/10; H01G 9/15

(57) ABSTRACT

A capacitor that includes: a capacitor layer including a first electrode layer and a second electrode layer facing each other in a thickness direction with a dielectric layer interposed therebetween; and a coaxial through-hole conductor penetrating through the capacitor layer in the thickness direction, wherein the coaxial through-hole conductor includes: a first through-hole conductor electrically coupled to an end surface of the first electrode layer; and a second through-hole conductor inside the first through-hole conductor and electrically coupled to the second electrode layer, wherein the first through-hole conductor and the second through-hole conductor are insulated from each other.

### CROSS REFERENCE TO RELATED APPLICATIONS

The present application is a continuation of International application No. PCT/JP2023/013955, filed Apr. 4, 2023, which claims priority to Japanese Patent Application No. 2022-079550, filed May 13, 2022, the entire contents of each of which are incorporated herein by reference.

### TECHNICAL FIELD

The present disclosure relates to a capacitor.

### BACKGROUND ART

A semiconductor package in recent years mainly has a multilayer structure in which a plurality of substrate layers are laminated. Further, in order to supply a signal or power to a semiconductor chip, a signal transmission line via a through-electrode is provided in most cases.

In a high-performance semiconductor device for use in artificial intelligence (AI), a data center, or the like, the signal transmission line is further complicated, and a power supply capacity is increased as the performance becomes higher.

As a result, high power (high current) supply via a through-electrode is required, and thus the through-electrode is also required to have a high current capacity, that is, to be capable of flowing a large amount of current.

When an electronic component is embedded in a substrate, an area for embedding the electronic component need be considered, and thus an area for providing a through-electrode is further limited. This makes it more difficult to secure a current capacity.

Patent Document 1 discloses a module used in a semiconductor composite device to supply a load with a DC voltage regulated by a voltage regulator including a semiconductor active element. The module includes a capacitor layer including at least one capacitor portion forming a capacitor, a coupling terminal used for electrical coupling to at least one of the voltage regulator and the load, and a through-hole conductor formed to penetrate through the capacitor portion in a thickness direction of the capacitor layer. The capacitor is electrically coupled to at least one of the load and the voltage regulator via the through-hole conductor.
Patent Document 1: International Publication No. 2021/241325

### SUMMARY OF THE DISCLOSURE

FIG. 21 of Patent Document 1 illustrates an example of a capacitor layer in which a plurality of capacitor portions are disposed in a plane. In FIG. 21 of Patent Document 1, each capacitor portion is provided with a first through-hole conductor electrically coupled to an anode of the capacitor portion and a second through-hole conductor electrically coupled to a cathode of the capacitor portion.

As illustrated in FIG. 17 to FIG. 20 of Patent Document 1, an insulating region need be secured around a through-hole conductor constituting a through-electrode.

In the above configuration, in order to increase the current capacity of the through-electrode, methods such as (1) increasing the number of through-electrodes and (2) increasing the volume of through-electrode (for example, increasing the diameter of through-electrode) are conceived. However, in the methods above, an insulating region required for forming the through-electrode increases as well.

Since the insulating region is a region that does not exhibit capacitor capacitance, when the insulating region increases, the region that exhibits capacitor capacitance decreases. Thus, since a current capacity and capacitor capacitance are in a trade-off relationship, it is hard to simultaneously satisfy a desired current capacity and capacitor capacitance.

It is an object of the present disclosure to provide a capacitor capable of reducing a region that does not exhibit capacitor capacitance even when a through-hole conductor constituting a through-electrode is provided.

A capacitor of the present disclosure includes: a capacitor layer including a first electrode layer and a second electrode layer facing each other in a thickness direction with a dielectric layer interposed therebetween; and a coaxial through-hole conductor penetrating through the capacitor layer in the thickness direction, wherein the coaxial through-hole conductor includes: a first through-hole conductor electrically coupled to an end surface of the first electrode layer; and a second through-hole conductor inside the first through-hole conductor and electrically coupled to the second electrode layer, wherein the first through-hole conductor and the second through-hole conductor are insulated from each other.

According to the present disclosure, it is possible to provide a capacitor capable of reducing a region that does not exhibit capacitor capacitance even when a through-hole conductor constituting a through-electrode is provided.

### BRIEF DESCRIPTION OF THE DRAWINGS

FIG. 1 is a sectional view schematically illustrating an example of a capacitor of the present disclosure.

FIG. 2 is a plan view of the capacitor in a P1 plane illustrated in FIG. 1.

FIG. 3 is a sectional view schematically illustrating an example of a capacitor according to a comparative embodiment of the present disclosure, in which a first through-hole conductor and a second through-hole conductor are provided to be separated from each other.

FIG. 4 is a plan view of the capacitor in a P1 plane according to the comparative embodiment illustrated in FIG. 3.

FIG. 5 is a plan view schematically illustrating an example of an area of a region that does not exhibit capacitor capacitance in a structure according to the comparative embodiment illustrated in FIG. 4.

FIG. 6 is a plan view schematically illustrating an example of an area of a region that does not exhibit capacitor capacitance in a structure illustrated in FIG. 2.

FIG. 7 is a plan view of the capacitor illustrated in FIG. 1 in a P2 plane.

FIG. 8 is a plan view of the capacitor illustrated in FIG. 1 in a P3 plane.

FIG. 9 is a plan view of the capacitor illustrated in FIG. 1 in a P4 plane.

FIG. 10 is a plan view of the capacitor illustrated in FIG. 1 in a P5 plane.

FIG. 11 is a sectional view schematically illustrating another example of the capacitor of the present disclosure.

FIG. 12 is a plan view of the capacitor in a P1 plane illustrated in FIG. 11.

FIG. 13 is a sectional view schematically illustrating still another example of the capacitor of the present disclosure.

FIG. 14 is a diagram schematically illustrating a planar layout of the capacitor illustrated in FIG. 13.

FIG. 15 illustrates a relationship between through-hole conductors and a relationship between each through-hole conductor and a via conductor coupled to a second electrode layer, in the planar layout illustrated in FIG. 14.

FIG. 16 is a diagram for explaining a method of manufacturing the capacitor illustrated in FIG. 13, and is a sectional view schematically illustrating a capacitor at a stage before sealing with an outer sealing layer.

FIG. 17 is another diagram for explaining the method of manufacturing the capacitor illustrated in FIG. 13, and is a sectional view schematically illustrating a capacitor at a stage in which a through-hole is formed in the outer sealing layer.

### DESCRIPTION OF THE PREFERRED EMBODIMENTS

A capacitor of the present disclosure will be described below.

The present disclosure is not limited to the following configurations, and can be appropriately modified and applied within a range not departing from the gist of the present disclosure. The present disclosure also includes combinations of two or more individual desirable configurations of the present disclosure described below.

The drawings described below are schematic views, and dimensions, a scale of an aspect ratio, and the like may be different from those of an actual product.

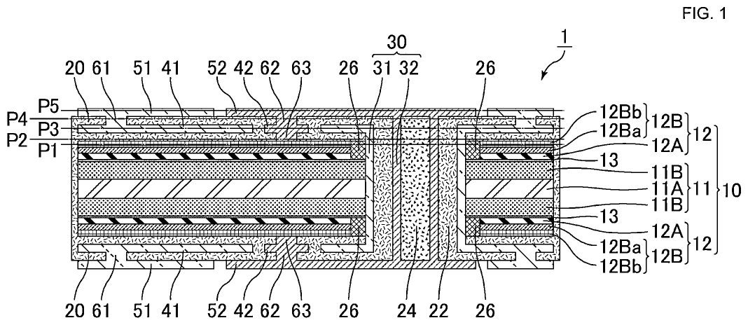

FIG. 1 is a sectional view schematically illustrating an example of a capacitor of the present disclosure.

A capacitor 1 illustrated in FIG. 1 includes a capacitor layer 10, a sealing layer 20 that seals the capacitor layer 10, and a coaxial through-hole conductor 30 provided to penetrate through the capacitor layer 10 in a thickness direction of the capacitor layer 10.

The capacitor layer 10 includes a first electrode layer and a second electrode layer facing each other in the thickness direction with a dielectric layer interposed therebetween.

In the example illustrated in FIG. 1, the first electrode layer is an anode plate 11, and the second electrode layer is a cathode layer 12. With these, the capacitor layer 10 constitutes an electrolytic capacitor.

The anode plate 11 includes, for example, a metal core portion 11A and a porous portion 11B provided on at least one main surface of the core portion 11A. A dielectric layer 13 is provided on a surface of the porous portion 11B, and the cathode layer 12 is provided on a surface of the dielectric layer 13.

The cathode layer 12 includes, for example, a solid electrolyte layer 12A provided on the surface of the dielectric layer 13. The cathode layer 12 preferably further includes a conductor layer 12B provided on a surface of the solid electrolyte layer 12A. The conductor layer 12B includes, for example, a carbon layer 12Ba provided on the surface of the solid electrolyte layer 12A and a copper layer 12Bb provided on a surface of the carbon layer 12Ba.

The capacitor layer 10 may constitute, for example, a ceramic capacitor using barium titanate or the like, or a capacitor such as a thin film capacitor using silicon nitride (SiN), silicon dioxide (SiO₂), hydrogen fluoride (HF), or the like, not limited to an electrolytic capacitor such as a solid electrolytic capacitor. However, from a viewpoint of capability of forming the capacitor layer 10 being thinner and having a relatively large area, and mechanical characteristics such as rigidity and flexibility of the capacitor 1, the capacitor layer 10 preferably constitutes a capacitor using a metal such as aluminum as a base material, and more preferably constitutes an electrolytic capacitor using a metal such as aluminum as a base material.

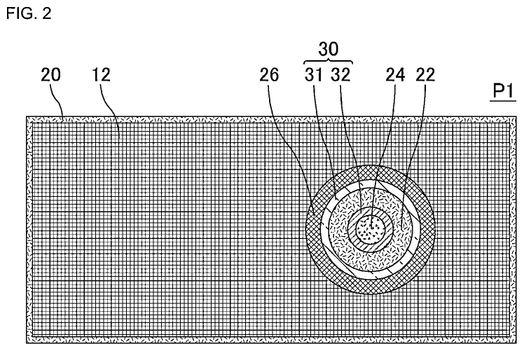

FIG. 2 is a plan view of the capacitor in a P1 plane illustrated in FIG. 1.

As illustrated in FIG. 1 and FIG. 2, the coaxial through-hole conductor 30 includes a first through-hole conductor 31 electrically coupled to the first electrode layer (anode plate 11 in the example illustrated in FIG. 1) and a second through-hole conductor 32 electrically coupled to the second electrode layer (cathode layer 12 in the example illustrated in FIG. 1).

In the coaxial through-hole conductor 30, as illustrated in FIG. 1, the first through-hole conductor 31 is electrically coupled to an end surface of the first electrode layer (anode plate 11 in the example illustrated in FIG. 1) at a side wall thereof, for example. This makes a distance from the first through-hole conductor 31 to a capacitance effective portion of the capacitor layer 10 short, and thus the capacitor 1 having excellent frequency characteristics may be designed.

In the coaxial through-hole conductor 30, the second through-hole conductor 32 is provided inside the first through-hole conductor 31, and the first through-hole conductor 31 and the second through-hole conductor 32 are insulated from each other. For example, a space between the first through-hole conductor 31 and the second through-hole conductor 32 is filled with an insulating material 22.

As long as the second through-hole conductor 32 is provided inside the first through-hole conductor 31, an axis of the second through-hole conductor 32 need not coincide with an axis of the first through-hole conductor 31, but preferably coincides with the axis of the first through-hole conductor 31 as illustrated in FIG. 1 and FIG. 2. The term “coincide” used herein does not necessarily mean to exactly coincide. For example, when viewed from the thickness direction of the capacitor layer 10, a distance between the axis of the first through-hole conductor 31 and the axis of the second through-hole conductor 32 need be within a range of approximately 3% or less of a diameter of the second through-hole conductor 32.

The inside of the second through-hole conductor 32 may be filled with a material containing a resin. That is, a resin filling portion 24 may be provided inside the second through-hole conductor 32.

It is preferable that an insulating layer 26 be provided around the first through-hole conductor 31. In the example illustrated in FIG. 1 and FIG. 2, the insulating layer 26 is provided between the first through-hole conductor 31 and the cathode layer 12.

In FIG. 2, an inner region from an outer peripheral edge of the insulating layer 26 provided around the first through-hole conductor 31 corresponds to a region that does not exhibit capacitor capacitance.

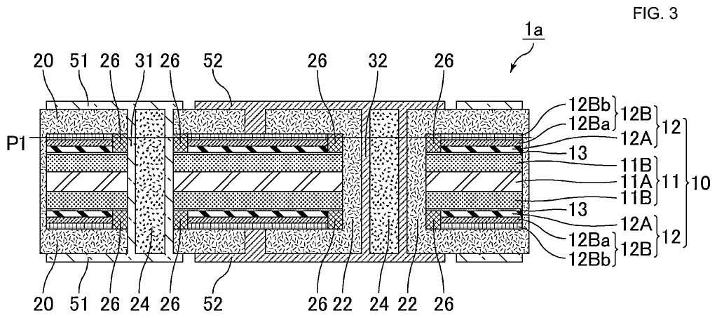

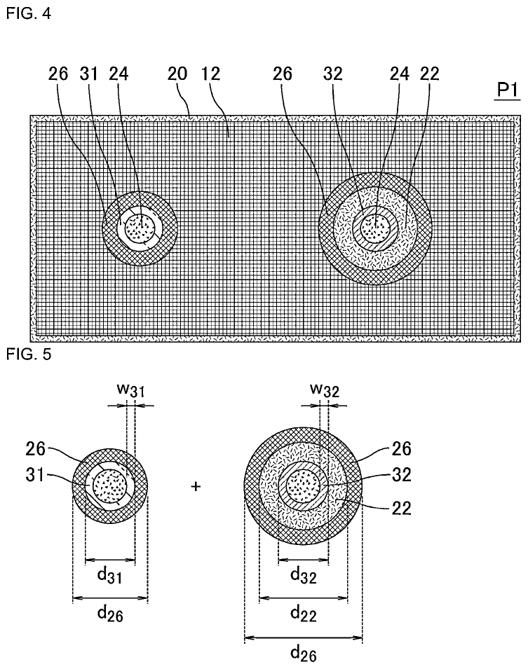

FIG. 3 is a sectional view schematically illustrating an example of a capacitor according to a comparative embodiment of the present disclosure in which a first through-hole conductor and a second through-hole conductor are provided to be separated from each other. FIG. 4 is a plan view of the capacitor in a P1 plane according to the comparative embodiment illustrated in FIG. 3.

In a capacitor 1a illustrated in FIG. 3, the first through-hole conductor 31 and the second through-hole conductor 32 are provided to be separated from each other.

The first through-hole conductor 31 is electrically coupled to the end surface of the first electrode layer (anode plate 11 in the example illustrated in FIG. 3) at the side wall thereof, for example. A space between the second through-hole conductor 32 and the capacitor layer 10 may be filled with the insulating material 22.

The resin filling portion 24 may be provided inside the first through-hole conductor 31. Similarly, the resin filling portion 24 may be provided inside the second through-hole conductor 32.

As illustrated in FIG. 3 and FIG. 4, it is preferable that the insulating layer 26 be provided around the first through-hole conductor 31. Similarly, it is preferable that the insulating layer 26 be provided around the second through-hole conductor 32. In the example illustrated in FIG. 3 and FIG. 4, the insulating layer 26 is provided between the first through-hole conductor 31 and the cathode layer 12 or between the second through-hole conductor 32 and the cathode layer 12.

In FIG. 4, the sum of the inner region from the outer peripheral edge of the insulating layer 26 provided around the first through-hole conductor 31 and the inner region from the outer peripheral edge of the insulating layer 26 provided around the second through-hole conductor 32 corresponds to the region that does not exhibit capacitor capacitance.

In FIG. 2 and FIG. 4, when current capacities of the first through-hole conductor 31 and the second through-hole conductor 32 (conductor areas in FIG. 2 and FIG. 4) are the same, the region that does not exhibit capacitor capacitance may be made smaller by providing the second through-hole conductor 32 inside the first through-hole conductor 31 than by providing the first through-hole conductor 31 and the second through-hole conductor 32 separated from each other.

FIG. 5 is a plan view schematically illustrating an example of an area of the region that does not exhibit capacitor capacitance in a structure according to the comparative embodiment illustrated in FIG. 4.

For example, when a diameter d₃₁ of the first through-hole conductor 31 is 125 μm, a width w₃₁ of the first through-hole conductor 31 is 15 μm (area of the first through-hole conductor 31 is 5184 μm²), a diameter d₂₆ of the insulating layer 26 provided around the first through-hole conductor 31 is 435 μm, a diameter d₃₂ of the second through-hole conductor 32 is 125 μm, a width w₃₂ of the second through-hole conductor 32 is 15 μm (area of the second through-hole conductor 32 is 5184 μm²), a diameter d₂₂ of the insulating material 22 provided around the second through-hole conductor 32 is 255 μm, and a diameter d₂₆ of the insulating layer 26 provided around the insulating material 22 is 565 μm, an area S of the region that does not exhibit capacitor capacitance is calculated as follows:

S=π(435/2)²+π(565/2)²≈399336 [μm²]

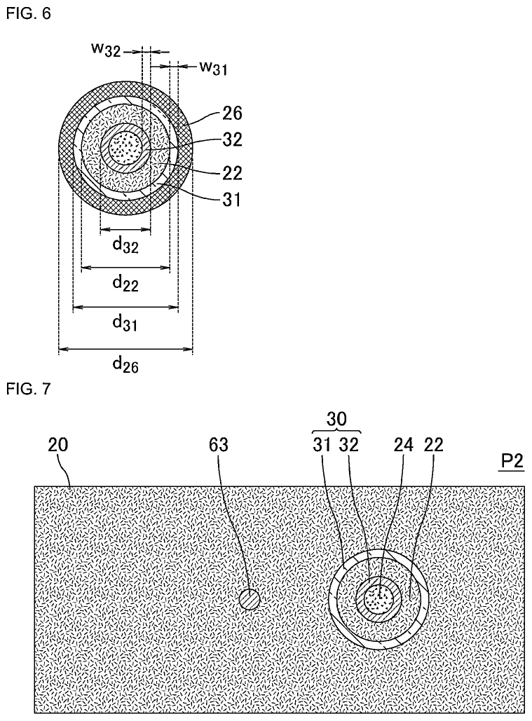

FIG. 6 is a plan view schematically illustrating an example of an area of the region that does not exhibit capacitor capacitance in a structure illustrated in FIG. 2.

For example, when the diameter d₃₂ of the second through-hole conductor 32 is 125 μm, the width w₃₂ of the second through-hole conductor 32 is 15 μm (area of the second through-hole conductor 32 is 5184 μm²), the diameter d₂₂ of the insulating material 22 provided around the second through-hole conductor 32 is 255 μm, the diameter d₃₁ of the first through-hole conductor 31 is 270 μm, the width w₃₁ of the first through-hole conductor 31 is 7.5 μm (area of the first through-hole conductor 31 is 6185 μm²), and the diameter d₂₆ of the insulating layer 26 provided around the first through-hole conductor 31 is 580 μm, an area S of the region that does not exhibit capacitor capacitance is calculated as follows:

S=π(580/2)²≈264208 [μm²]

In FIG. 6, the area S of the region that does not exhibit capacitor capacitance required per one set of the first through-hole conductor 31 and the second through-hole conductor 32 may be reduced by approximately 30% as compared with that in FIG. 5.

By providing the second through-hole conductor 32 inside the first through-hole conductor 31 as described above, an area density of the coaxial through-hole conductor 30 in the region that does not exhibit capacitor capacitance may be increased. This makes it possible to increase the area of the capacitance effective portion of the capacitor layer 10. Alternatively, disposing more coaxial through-hole conductors 30 may increase the current capacity.

As described above, the width w₃₁ of the first through-hole conductor 31 may be smaller than the width w₃₂ of the second through-hole conductor 32. Even in this case, since the first through-hole conductor 31 is provided outside the second through-hole conductor 32, and the diameter d₃₁ thereof is larger than the diameter d₃₂ of the second through-hole conductor 32, the current capacities (conductive areas in FIG. 2) of the first through-hole conductor 31 and the second through-hole conductor 32 may be made almost equal to each other.

Note that a width of a through-hole conductor means a thickness of the through-hole conductor and is a measurement corresponding to {(outer diameter of through-hole conductor)−(inner diameter of through-hole conductor)}/2. Here, the outer diameter of the through-hole conductor corresponds to the diameter d₃₁ of the first through-hole conductor 31 or the diameter d₃₂ of the second through-hole conductor 32.

The coaxial through-hole conductor 30, in which the second through-hole conductor 32 is provided inside the first through-hole conductor 31, is formed as follows, for example.

First, a first through-hole is formed by performing drilling, laser processing, or the like on a portion where the first through-hole conductor 31 is to be formed. An inner wall surface of the first through-hole is metallized with a low-resistance metal such as copper, gold, or silver, for example, to form the first through-hole conductor 31. When the first through-hole conductor 31 is formed, for example, metallizing the inner wall surface of the first through-hole by electroless copper plating, electrolytic copper plating, or the like makes the processing be easier.

Next, an inside of the first through-hole conductor 31 is filled with the insulating material 22. A second through-hole is formed by performing drilling, laser processing, or the like on the filled insulating material 22. At this time, a hole diameter of the second through-hole is made smaller than a hole diameter of the first through-hole conductor 31, so that the insulating material 22 is present between the first through-hole conductor 31 and the second through-hole. Thereafter, an inner wall surface of the second through-hole is metallized with a low-resistance metal such as copper, gold, or silver, for example, to form the second through-hole conductor 32. When the second through-hole conductor 32 is formed, for example, metallizing the inner wall surface of the second through-hole by electroless copper plating, electrolytic copper plating, or the like makes the processing be easier.

Note that the first through-hole conductor 31 and the second through-hole conductor 32 may be any conductor that penetrates through the capacitor layer, and the method of forming the conductor is not particularly limited to plating. For example, the method of forming the second through-hole conductor 32 may be a method of filling the second through-hole with a metal, a composite material of a metal and a resin, or the like as in a case of a via conductor, in addition to the method of metallizing the inner wall surface of the second through-hole.

Although not illustrated in FIG. 1, the capacitor 1 may further include a through-hole conductor other than the coaxial through-hole conductor 30. For example, the capacitor 1 may further include a through-hole conductor that is not electrically coupled to any of the first electrode layer and the second electrode layer of the capacitor layer 10.

As illustrated in FIG. 1, the capacitor 1 preferably further includes inner wiring layers 41 and 42 provided inside the sealing layer 20. The inner wiring layers 41 and 42 are preferably provided along a main surface direction orthogonal to the thickness direction of the capacitor layer 10. In the example illustrated in FIG. 1, the inner wiring layers 41 and 42 are provided to both main surface sides of the capacitor layer 10, but may be provided to only one main surface side.

The capacitor 1 preferably further includes outer wiring layers 51 and 52 provided on a surface of the sealing layer 20. The outer wiring layers 51 and 52 are preferably provided along the main surface direction orthogonal to the thickness direction of the capacitor layer 10. In the example illustrated in FIG. 1, the outer wiring layers 51 and 52 are provided to both the main surface sides of the capacitor layer 10, but may be provided to only one main surface side.

The capacitor 1 preferably further includes via conductors 61, 62, and 63 provided inside the sealing layer 20. The via conductors 61, 62, and 63 are preferably provided along the thickness direction of the capacitor layer 10. One end of the via conductor 61 is coupled to the inner wiring layer 41, and the other end is coupled to the outer wiring layer 51. One end of the via conductor 62 is coupled to the inner wiring layer 42, and the other end is coupled to the outer wiring layer 52. One end of the via conductor 63 is coupled to the second electrode layer (cathode layer 12 in the example illustrated in FIG. 1) of the capacitor layer 10, and the other end is coupled to the inner wiring layer 42.

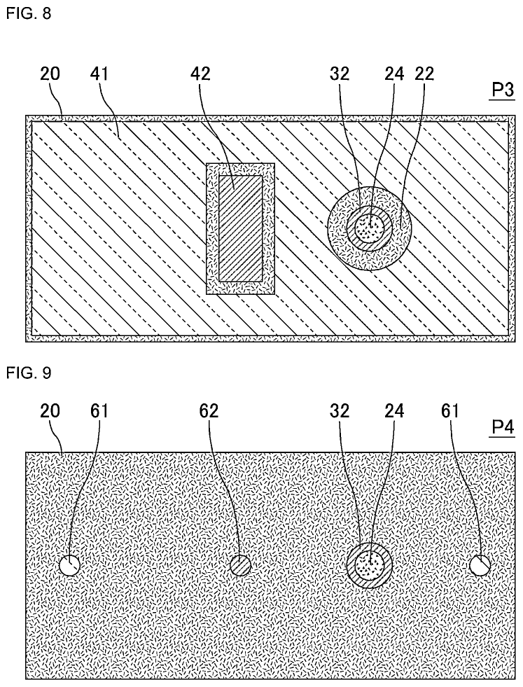

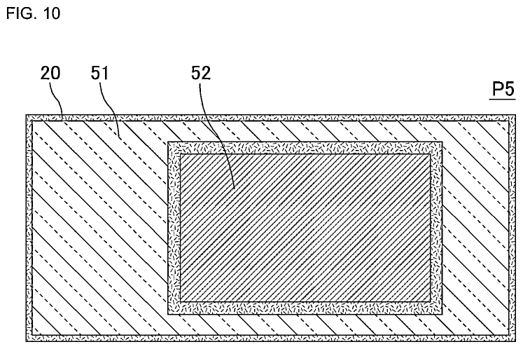

FIG. 7 is a plan view of the capacitor illustrated in FIG. 1 in a P2 plane. FIG. 8 is a plan view of the capacitor illustrated in FIG. 1 in a P3 plane. FIG. 9 is a plan view of the capacitor illustrated in FIG. 1 in a P4 plane. FIG. 10 is a plan view of the capacitor illustrated in FIG. 1 in a P5 plane.

In the examples illustrated in FIG. 1, FIG. 7, FIG. 8, FIG. 9, and FIG. 10, the first electrode layer (anode plate 11 in the example illustrated in FIG. 1) of the capacitor layer 10 is electrically coupled to the outer wiring layer 51 via the first through-hole conductor 31, the inner wiring layer 41, and the via conductor 61. As described above, it is preferable that the first electrode layer be electrically extended to the surface of the sealing layer 20 via the first through-hole conductor 31 and the inner wiring layer 41. The outer wiring layer 51 may function as a coupling terminal of the capacitor layer 10.

In the example illustrated in FIG. 1, FIG. 7, FIG. 8, FIG. 9, and FIG. 10, the second through-hole conductor 32 is electrically coupled to the second electrode layer (cathode layer 12 in the example illustrated in FIG. 1) of the capacitor layer 10 via the outer wiring layer 52, the via conductor 62, the inner wiring layer 42, and the via conductor 63. As described above, the second through-hole conductor 32 is preferably provided to penetrate through both the capacitor layer 10 and the sealing layer 20 in the thickness direction of the capacitor layer 10. The outer wiring layer 52 may function as the coupling terminal of the capacitor layer 10.

In the example illustrated in FIG. 9, the second through-hole conductor 32, the via conductor 61, and the via conductor 62 are disposed in a straight line when viewed from the thickness direction of the capacitor layer 10, but need not be disposed in a straight line. The number of via conductors 61 and via conductors 62 is not particularly limited, and one of each may be present, or the plurality of via conductors 61 and the plurality of via conductors 62 may be present.

When the capacitor layer 10 includes the anode plate 11 and the cathode layer 12, the anode plate 11 is preferably made of a valve-action metal exhibiting a so-called valve action. Examples of the valve-action metal include a metal element such as aluminum, tantalum, niobium, titanium, or zirconium, or an alloy containing at least one of these metals. Among these, aluminum or an aluminum alloy is preferable.

A shape of the anode plate 11 is preferably a flat plate shape, and more preferably a foil shape. The anode plate 11 may have the porous portion 11B on at least one main surface of the core portion 11A, and may have the porous portion 11B on both main surfaces of the core portion 11A. The porous portion 11B is preferably a porous layer formed on a surface of the core portion 11A, and more preferably an etching layer.

A thickness of the anode plate 11 before an etching treatment is preferably 60 μm to 200 μm. After the etching treatment, a thickness of the core portion 11A that is not etched is preferably 15 μm to 70 μm. A thickness of the porous portion 11B is designed in accordance with a required withstanding voltage and electrostatic capacity, and the total of the thicknesses of the porous portions 11B on both sides of the core portion 11A is preferably 10 μm to 180 μm.

A pore diameter of the porous portion 11B is preferably 10 nm to 600 nm. Note that the pore diameter of the porous portion 11B means a median diameter D50 measured by a mercury porosimeter. The pore diameter of the porous portion 11B may be controlled by adjusting various conditions in the etching, for example.

The dielectric layer 13 provided on the surface of the porous portion 11B is made to be porous reflecting a surface state of the porous portion 11B, and has a fine uneven surface shape. The dielectric layer 13 is preferably made of an oxide film of the valve-action metal. For example, when an aluminum foil is used as the anode plate 11, the dielectric layer 13 made of an oxide film may be formed by performing an anodic oxidation treatment (also referred to as a chemical conversion treatment) on a surface of the aluminum foil in an aqueous solution containing ammonium adipate or the like.

A thickness of the dielectric layer 13 is designed in accordance with a required withstanding voltage and electrostatic capacity, and is preferably 10 nm to 100 nm.

When the cathode layer 12 includes the solid electrolyte layer 12A, examples of the material constituting the solid electrolyte layer 12A include conductive polymers such as polypyrroles, polythiophenes, and polyanilines. Among these, polythiophenes are preferable, and poly (3, 4-ethylenedioxythiophene) called PEDOT is particularly preferable. The conductive polymer above may contain a dopant such as polystyrene sulfonic acid (PSS). The solid electrolyte layer 12A preferably includes an inner layer filling the pores (recesses) of the dielectric layer 13 and an outer layer covering the dielectric layer 13.

A thickness of the solid electrolyte layer 12A from the surface of the porous portion 11B is preferably 2 μm to 20 μm.

The solid electrolyte layer 12A is formed by, for example, a method of forming a polymer film of poly (3, 4-ethylenedioxythiophene) or the like on the surface of the dielectric layer 13 using a treatment liquid containing a monomer of 3, 4-ethylenedioxythiophene or the like, or a method of applying a dispersion liquid of a polymer of poly (3, 4-ethylenedioxythiophene) or the like to the surface of the dielectric layer 13 and drying the dispersion liquid.

The solid electrolyte layer 12A may be formed in a predetermined region by applying the treatment liquid or the dispersion liquid to the surface of the dielectric layer 13 by sponge transfer, screen-printing, a dispenser, ink-jet printing, or the like.

When the cathode layer 12 includes the conductor layer 12B, the conductor layer 12B includes at least one of a conductive resin layer and a metal layer. The conductor layer 12B may be formed of only a conductive resin layer or only a metal layer. The conductor layer 12B preferably covers the entire surface of the solid electrolyte layer 12A.

Examples of the conductive resin layer include a conductive adhesive layer containing at least one conductive filler selected from the group consisting of a silver filler, a copper filler, a nickel filler, and a carbon filler.

Examples of the metal layer include a metal plating film and a metal foil. The metal layer is preferably made of at least one metal selected from the group consisting of nickel, copper, silver, and alloys containing these metals as a main component. The “main component” refers to an element component having the largest weight ratio.

When the conductor layer 12B includes the carbon layer 12Ba and the copper layer 12Bb, the carbon layer 12Ba is provided to electrically and mechanically couple the solid electrolyte layer 12A and the copper layer 12Bb. The carbon layer 12Ba may be formed in a predetermined region by applying a carbon paste onto the solid electrolyte layer 12A by sponge transfer, screen-printing, a dispenser, ink-jet printing, or the like. It is preferable that the carbon layer 12Ba be laminated on the copper layer 12Bb in the next step in a viscous state before drying. A thickness of the carbon layer 12Ba is preferably 2 μm to 20 μm.

When the conductor layer 12B includes the carbon layer 12Ba and the copper layer 12Bb, the copper layer 12Bb may be formed by applying a copper paste on the carbon layer 12Ba by sponge transfer, screen-printing, spray coating, a dispenser, ink-jet printing, or the like. A thickness of the copper layer 12Bb is preferably 2 μm to 20 μm.

The sealing layer 20 is constituted of an insulating material. The sealing layer 20 is preferably constituted of an insulating resin. Examples of the insulating resin constituting the sealing layer 20 include an epoxy resin and a phenol resin. Further, the sealing layer 20 preferably contains a filler. Examples of the filler contained in the sealing layer 20 include an inorganic filler such as a silica particle, an alumina particle, and a metal particle.

In the example illustrated in FIG. 1, the sealing layer 20 is provided to both the main surface sides of the capacitor layer 10, but may be provided to only one main surface side. The sealing layer 20 provided to the one main surface side of the capacitor layer 10 may be constituted of only one layer or may be constituted of two or more layers. When the sealing layer 20 is constituted of two or more layers, the materials constituting the respective layers may be the same or different.

Between the capacitor layer 10 and the sealing layer 20, a layer such as a stress relaxation layer or a moisture-proof film may be provided, for example.

The stress relaxation layer is preferably constituted of an insulating resin. Examples of the insulating resin constituting the stress relaxation layer include an epoxy resin, a phenol resin, and a silicone resin. Further, the stress relaxation layer preferably contains a filler. Examples of the filler contained in the stress relaxation layer include an inorganic filler such as a silica particle, an alumina particle, and a metal particle. The insulating resin constituting the stress relaxation layer is preferably different from the insulating resin constituting the sealing layer 20.

The sealing layer 20 is required to have characteristics such as close contact property to outer electrodes (for example, outer wiring layers 51 and 52) as an exterior body. This makes it hard to unconditionally let a coefficient of linear expansion be equal to that of the capacitor layer 10 or to select a resin having any elastic modulus. In contrast, by providing the stress relaxation layer, thermal stress design may be adjusted without losing respective functions of the capacitor layer 10 and the sealing layer 20.

The stress relaxation layer preferably has moisture permeability lower than that of the sealing layer 20. In this case, in addition to achieving the adjustment of the stress, entry of moisture into the capacitor layer 10 may be reduced. The moisture permeability of the stress relaxation layer may be adjusted by the type of the insulating resin constituting the stress relaxation layer, the amount of the filler contained in the stress relaxation layer, and the like.

The insulating material 22 filled between the first through-hole conductor 31 and the second through-hole conductor 32 is preferably constituted of an insulating resin. Examples of the insulating resin constituting the insulating material 22 include an epoxy resin and a phenol resin. Furthermore, the insulating material 22 preferably contains a filler. Examples of the filler contained in the insulating material 22 include an inorganic filler such as a silica particle, an alumina particle, and a metal particle.

The insulating material 22 may be constituted of the same material as the material constituting the sealing layer 20. For example, as illustrated in FIG. 1, the sealing layer 20 may be filled between the first through-hole conductor 31 and the second through-hole conductor 32.

Alternatively, the insulating material 22 may be constituted of the same material as the stress relaxation layer described above. For example, when the capacitor 1 includes a stress relaxation layer, the stress relaxation layer may be filled between the first through-hole conductor 31 and the second through-hole conductor 32.

The insulating material 22 may have a coefficient of thermal expansion larger than, smaller than, or equal to that of a material (for example, copper) constituting the first through-hole conductor 31 and the second through-hole conductor 32.

When the resin filling portion 24 is provided inside the second through-hole conductor 32, the material constituting the resin filling portion 24 may have a coefficient of thermal expansion larger than, smaller than, or equal to that of a material (for example, copper) constituting the second through-hole conductor 32.

When the insulating layer 26 is provided around the first through-hole conductor 31 constituting the coaxial through-hole conductor 30, the insulating layer 26 is preferably constituted of an insulating resin. Examples of the insulating resin constituting the insulating layer 26 include a polyphenylsulfone resin, a polyethersulfone resin, a cyanate ester resin, a fluororesin (tetrafluoroethylene, tetrafluoroethylene-perfluoroalkyl vinyl ether copolymer, or the like), a polyimide resin, a polyamide-imide resin, an epoxy resin, and derivatives or precursors thereof.

The insulating layer 26 may be constituted of the same resin as the resin constituting the sealing layer 20. Unlike the sealing layer 20, the insulating layer 26 is preferably constituted of a resin alone since the capacitance effective portion of the capacitor layer 10 may adversely be affected when an inorganic filler is contained in the insulating layer 26.

The insulating layer 26 may be formed, for example, by applying a mask material such as a composition containing an insulating resin to the surface of the porous portion 11B by a method such as sponge transfer, screen-printing, a dispenser, or ink-jet printing.

A thickness of the insulating layer 26 from the surface of the porous portion 11B is preferably 20 μm or less. The thickness of the insulating layer 26 from the surface of the porous portion 11B may be 0 μm, but is preferably 2 μm or more.

In the example illustrated in FIG. 1, the insulating layer 26 is provided around the first through-hole conductor 31 by filling the porous portion 11B, exposed at an end surface of the anode plate 11 electrically coupled to the first through-hole conductor 31, with an insulating material. Filling the insulating material in the porous portion 11B around a certain circumference of the first through-hole conductor 31 makes the insulating property between the anode plate 11 and the cathode layer 12 be secured, and thus, short-circuiting may be prevented. Furthermore, suppressing the dissolution of the end surface of the anode plate 11 that occurs during chemical treatment for forming wiring layers such as the inner wiring layers 41 and 42 makes it possible to prevent the chemical solution from entering the capacitor layer 10, and thus the reliability of the capacitor 1 is increased.

It is acceptable that the insulating layer 26 is filled inside the porous portion 11B and is provided on the surface of the porous portion 11B on top of the filled portion. That is, the thickness of the insulating layer 26 may be larger than the thickness of the porous portion 11B.

An anode coupling layer may be provided between the first through-hole conductor 31 and the end surface of the anode plate 11. That is, the first through-hole conductor 31 may be electrically coupled to the end surface of the anode plate 11 via the anode coupling layer. When the anode coupling layer is provided between the first through-hole conductor 31 and the end surface of the anode plate 11, the anode coupling layer functions as a barrier layer for the anode plate 11. As a result, suppressing the dissolution of the anode plate 11 that occurs during chemical treatment for forming wiring layers such as the inner wiring layers 41 and 42 makes it possible to prevent the chemical solution from entering the capacitor layer 10, and thus the reliability of the capacitor 1 is increased.

When the anode coupling layer is provided between the first through-hole conductor 31 and the end surface of the anode plate 11, the anode coupling layer includes, for example, a first anode coupling layer mainly made of zinc as a main material and a second anode coupling layer mainly made of nickel or copper as a main material in order from the anode plate 11. For example, after the first anode coupling layer is formed on the end surface of the anode plate 11 by substituting and depositing zinc by a zincate treatment, the second anode coupling layer is formed on the first anode coupling layer by an electroless nickel plating or an electroless copper plating. The first anode coupling layer may disappear, and in this case, the anode coupling layer may include only the second anode coupling layer.

Note that no anode coupling layer may be provided between the first through-hole conductor 31 and the end surface of the anode plate 11. In this case, the first through-hole conductor 31 is directly coupled to the end surface of the anode plate 11.

As illustrated in FIG. 2, it is preferable that the first through-hole conductor 31 be electrically coupled to the end surface of the first electrode layer (for example, anode plate 11) over the entire circumference. In this case, a contact area between the first through-hole conductor 31 and the first electrode layer is increased, and thus coupling resistance with the first through-hole conductor 31 reduces. This makes it possible to reduce equivalent series resistance (ESR) of the capacitor 1. Furthermore, since the close contact property between the first through-hole conductor 31 and the first electrode layer is increased, a problem such as separation at a coupling surface due to thermal stress is less likely to occur.

Examples of the constituent material of the inner wiring layers 41 and 42 include a low-resistance metal such as silver, gold, or copper. The constituent material of the inner wiring layer 41 may be the same as or different from the constituent material of the inner wiring layer 42. The inner wiring layers 41 and 42 are formed by plating or the like, for example.

In order to increase the close contact property between the inner wiring layers 41 and 42 and another member, for example, the close contact property between the inner wiring layer 41 and the first through-hole conductor 31, a mixed material of a resin and at least one conductive filler selected from the group consisting of a silver filler, a copper filler, a nickel filler, and a carbon filler may be provided as the constituent material of the inner wiring layers 41 and 42.

Examples of the constituent material of the outer wiring layers 51 and 52 include a low-resistance metal such as silver, gold, or copper. The constituent material of the outer wiring layer 51 may be the same as or different from the constituent material of the outer wiring layer 52. The constituent material of the outer wiring layers 51 and 52 may be the same as or different from the constituent material of the inner wiring layers 41 and 42. The outer wiring layers 51 and 52 are formed by plating or the like, for example.

In order to increase the close contact property between the outer wiring layer 51 or 52 and another member, for example, the close contact property between the outer wiring layer 52 and the second through-hole conductor 32, a mixed material of a resin and at least one conductive filler selected from the group consisting of a silver filler, a copper filler, a nickel filler, and a carbon filler may be provided as the constituent material of the outer wiring layers 51 and 52.

Examples of the constituent material of the via conductors 61, 62, and 63 include the same constituent material of the inner wiring layers 41 and 42. The via conductors 61, 62, and 63 are formed by, for example, plating, a heat treatment of a conductive paste, or the like.

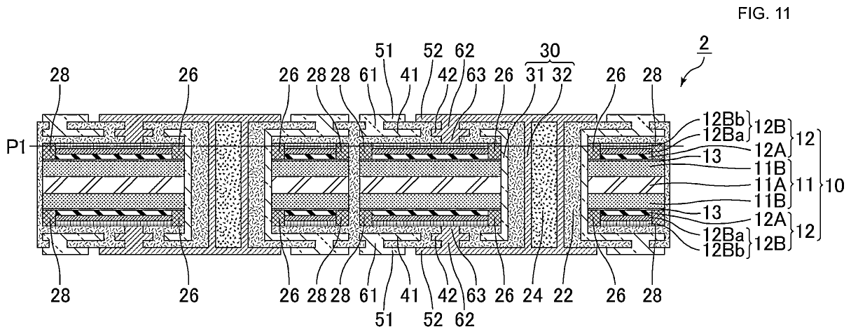

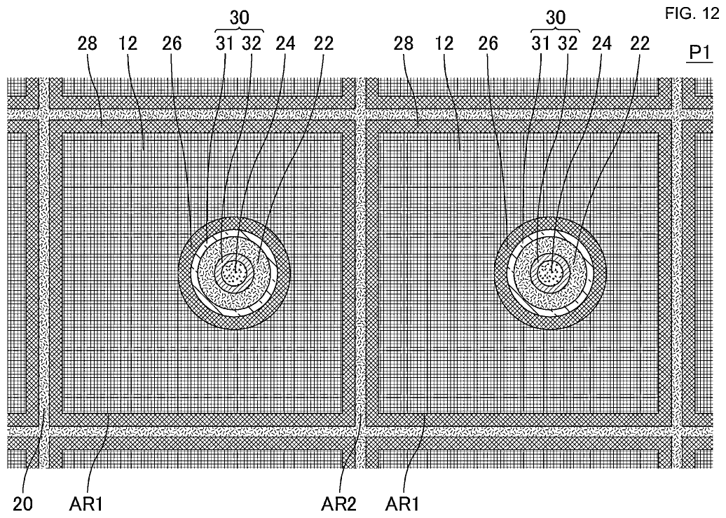

FIG. 11 is a sectional view schematically illustrating another example of the capacitor of the present disclosure. FIG. 12 is a plan view of the capacitor in a P1 plane illustrated in FIG. 11.

As in a capacitor 2 illustrated in FIG. 11 and FIG. 12, the capacitor layer 10 may include two or more capacitance effective portions AR1 and an insulation partitioning portion AR2 that partitions the capacitance effective portions AR1 when viewed from the thickness direction of the capacitor layer 10.

The capacitance effective portion AR1 is a region where the first electrode layer (anode plate 11 in the example in FIG. 11 and FIG. 12) and the second electrode layer (cathode layer 12 in the example in FIG. 11 and FIG. 12) face each other with the dielectric layer 13 interposed therebetween in the thickness direction of the capacitor layer 10.

The capacitor layer 10 is divided between the adjacent capacitance effective portions AR1. The capacitor layer 10 need be physically divided between the adjacent capacitance effective portions AR1. In that case, the capacitor layer 10 may electrically be divided or electrically be coupled between the adjacent capacitance effective portions AR1. When the capacitor layer 10 includes three or more capacitance effective portions AR1, there may be mixed the capacitance effective portions AR1 in which adjacent capacitor layers 10 are electrically separated from each other and the capacitance effective portions AR1 in which adjacent capacitor layers 10 are electrically coupled to each other.

As illustrated in FIG. 11 and FIG. 12, it is preferable that at least one coaxial through-hole conductor 30 be present inside the capacitance effective portion AR1. Disposing the through-hole conductor inside the capacitance effective portion AR1 makes it possible to ensure flexibility in designing a high-capacity power supply line, as compared with a case that the through-hole conductors are disposed in a periphery of the capacitance effective portion AR1.

It is preferable that at least one coaxial through-hole conductor 30 be present inside at least one of the two or more capacitance effective portions AR1, and it is more preferable that at least one coaxial through-hole conductor 30 be present inside each capacitance effective portion AR1. The number of coaxial through-hole conductors 30 present inside the capacitance effective portion AR1 may be the same, or may be different in some or all of the capacitance effective portions AR1.

The insulation partitioning portion AR2 is provided to surround the capacitance effective portion AR1 when viewed from the thickness direction of the capacitor layer 10.

In the example illustrated in FIG. 11 and FIG. 12, an insulating layer 28 is provided to surround the cathode layer 12 when viewed from the thickness direction of the capacitor layer 10. Furthermore, the portion where the capacitor layer 10 is divided is filled with the sealing layer 20. In this case, the insulation partitioning portion AR2 is formed by the insulating layer 28 and the sealing layer 20.

When the insulating layer 28 is provided to surround the cathode layer 12, the insulating layer 28 is preferably constituted of an insulating resin. Examples of the insulating resin constituting the insulating layer 28 include a polyphenylsulfone resin, a polyethersulfone resin, a cyanate ester resin, a fluororesin (tetrafluoroethylene, tetrafluoroethylene-perfluoroalkyl vinyl ether copolymer, or the like), a polyimide resin, a polyamide-imide resin, an epoxy resin, and derivatives or precursors thereof. The insulating layer 28 may be constituted of the same insulating resin as, or a different insulating resin from the insulating resin constituting the insulating layer 26.

The insulating layer 28 may be constituted of the same resin as the resin constituting the sealing layer 20. Unlike the sealing layer 20, the insulating layer 28 is preferably constituted of a resin alone since the capacitance effective portion AR1 of the capacitor layer 10 may adversely be affected when an inorganic filler is contained in the insulating layer 28.

The number of the capacitance effective portions AR1 is not particularly limited as long as it is two or more. The capacitance effective portions AR1 may be disposed in a linear or a planar arrangement when viewed from the thickness direction of the capacitor layer 10. The capacitance effective portions AR1 may be disposed regularly or irregularly. The size, the planar shape, and the like of the capacitance effective portion AR1 when viewed in the thickness direction of the capacitor layer 10 may be the same, or may be different in some or all of the capacitance effective portions AR1. The capacitor layer 10 may include two or more types of capacitance effective portions AR1 having different areas when viewed in the thickness direction.

The capacitor layer 10 may include the capacitance effective portion AR1 whose planar shape is not rectangular when viewed in the thickness direction. In the present description, the term “rectangular” means a square or a rectangle. Accordingly, the capacitor layer 10 may include the capacitance effective portion AR1 having, for example, a planar shape of a polygonal shape such as a quadrangular shape other than a rectangular shape, a triangular shape, a pentagonal shape, or a hexagonal shape; a shape including a curved portion; a circular shape; or an elliptical shape. In this case, the capacitor layer 10 may include two or more types of capacitance effective portions AR1 having different planar shapes. It is acceptable that the capacitor layer 10 includes or does not include the capacitance effective portion AR1 having a rectangular planar shape, in addition to the capacitance effective portion AR1 having a non-rectangular planar shape.

All of the two or more capacitance effective portions AR1 may be surrounded by the insulation partitioning portion AR2, or there may be a capacitance effective portion AR1 that is not surrounded by the insulation partitioning portion AR2. In the capacitance effective portion AR1 surrounded by the insulation partitioning portion AR2, the entire capacitance effective portion AR1 may be surrounded by the insulation partitioning portion AR2, or part of the capacitance effective portion AR1 may be surrounded by the insulation partitioning portion AR2.

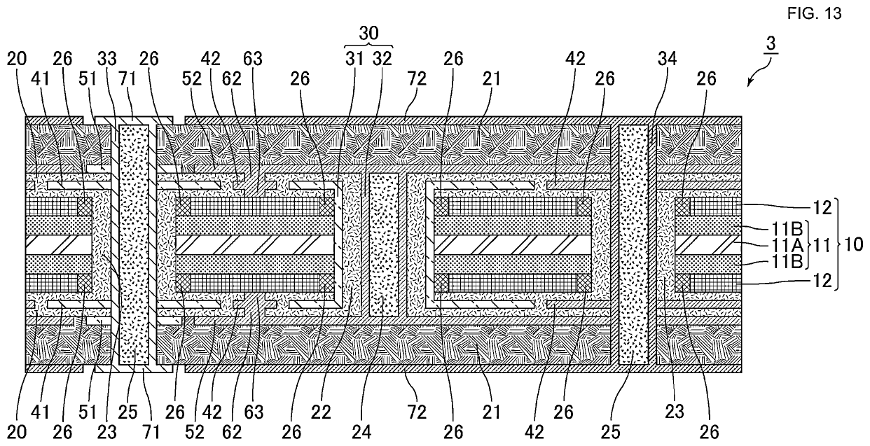

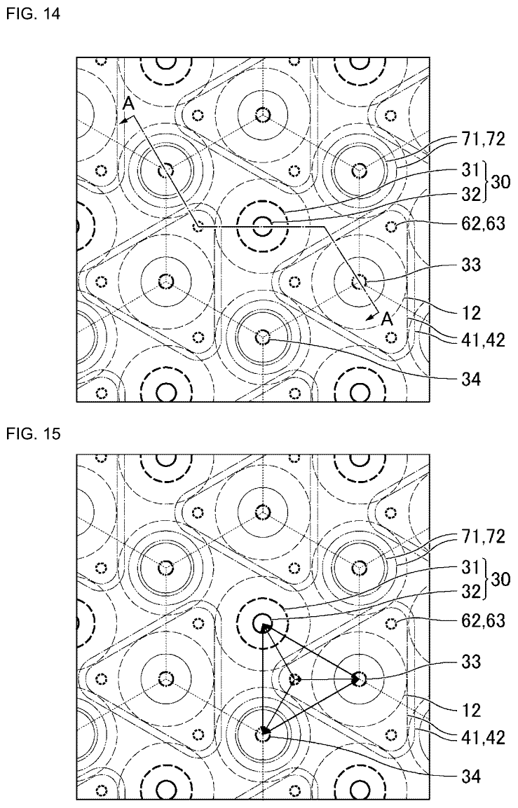

FIG. 13 is a sectional view schematically illustrating still another example of the capacitor of the present disclosure. FIG. 14 is a diagram schematically illustrating a planar layout of the capacitor illustrated in FIG. 13. FIG. 13 corresponds to a sectional view taken along a line A-A in FIG. 14. In FIG. 14, a thick broken line indicates the first through-hole conductor 31, a thick solid line indicates the second through-hole conductor 32, a thick dashed-and-double-dotted line indicates a third through-hole conductor 33, a thick dashed-and-dotted line indicates a fourth through-hole conductor 34, a thick dotted line indicates the via conductors 62 and 63, a thin dashed-and-dotted line indicates the inner wiring layers 41 and 42, a thin dashed-and-double-dotted line indicates outer wiring layers 71 and 72, a thin broken line indicates the cathode layer (second electrode layer) 12, a thin solid line indicates a through-hole provided in the anode plate (first electrode layer) 11, and a thin dotted line indicates an outline of one capacitance effective portion (unit) including one coaxial through-hole conductor 30.

As in a capacitor 3 illustrated in FIG. 13 and FIG. 14, the capacitor 1 illustrated in FIG. 1 may have a structure further sealed with an outer sealing layer 21, and may include the third through-hole conductor 33 and the fourth through-hole conductor 34 respectively penetrating through the outer sealing layer 21. The third through-hole conductor 33 is electrically coupled to the first electrode layer (anode plate 11) of the capacitor layer 10, and the fourth through-hole conductor 34 is electrically coupled to the second electrode layer (cathode layer 12).

At a position where the third through-hole conductor 33 and the fourth through-hole conductor 34 each are formed, a through-hole having a diameter larger than the diameter of each of the through-hole conductors is formed in the anode plate 11, and is filled with an insulating material 23.

The electrical coupling may be realized by coupling the third through-hole conductor 33 to a side surface of the inner wiring layer 41 and/or the outer wiring layer 51, and by coupling the fourth through-hole conductor 34 to a side surface of the inner wiring layer 42 and/or the outer wiring layer 52.

The outer sealing layer 21 is constituted of an insulating material. The insulating material constituting the outer sealing layer 21 may be the same as or different from the insulating material constituting the sealing layer 20. The outer sealing layer 21 is preferably constituted of an insulating resin. Further, the outer sealing layer 21 preferably contains a filler.

In the example illustrated in FIG. 13, the outer sealing layer 21 is provided to both main surface sides of the sealing layer 20, but may be provided to only one main surface side. The outer sealing layer 21 provided to the one main surface side of the sealing layer 20 may be constituted of only one layer or may be constituted of two or more layers. When the outer sealing layer 21 is constituted of two or more layers, materials constituting the respective layers may be the same or different.

The inside of each of the third through-hole conductor 33 and the fourth through-hole conductor 34 may be filled with a material containing a resin. That is, a resin filling portion 25 may be provided to the inside of each of the third through-hole conductor 33 and the fourth through-hole conductor 34.

The capacitor 3 may further include the outer wiring layers 71 and 72 provided on a surface of the outer sealing layer 21. The outer wiring layer 71 is coupled to the third through-hole conductor 33, and the outer wiring layer 72 is coupled to the fourth through-hole conductor 34.

As illustrated in FIG. 14, it is preferable that the coaxial through-hole conductors 30, the third through-hole conductors 33, and the fourth through-hole conductors 34 be regularly disposed in a honeycomb shape. In that case, it is preferable that the via conductors 62 and 63 be disposed at a center of an equilateral triangle formed by three centers of each of the coaxial through-hole conductor 30, the third through-hole conductor 33, and the fourth through-hole conductor 34 disposed in a honeycomb manner. Furthermore, it is preferable that the inner wiring layer 42 of the equilateral triangle shape be formed to include three via conductors 62 formed at the same distance from the center of the fourth through-hole conductor 34.

FIG. 15 illustrates a relationship between the through-hole conductors and a relationship between each through-hole conductor and a via conductor coupled to the second electrode layer, in the planar layout illustrated in FIG. 14.

As illustrated in FIG. 15, in the capacitor 3, it is preferable that a distance between the centers of the coaxial through-hole conductor 30 and the third through-hole conductor 33, a distance between the centers of the third through-hole conductor 33 and the fourth through-hole conductor 34, and a distance between the centers of the fourth through-hole conductor 34 and the coaxial through-hole conductor 30 be equal to one another (in FIG. 15, thick solid arrows each have an equal length). Further, it is preferable that a distance between the centers of the coaxial through-hole conductor 30 and each of the via conductors 62 and 63, a distance between the centers of the third through-hole conductor 33 and each of the via conductors 62 and 63, and a distance between the centers of the fourth through-hole conductor 34 and each of the via conductors 62 and 63 be equal to one another (in FIG. 15, thin solid arrows each have an equal length).

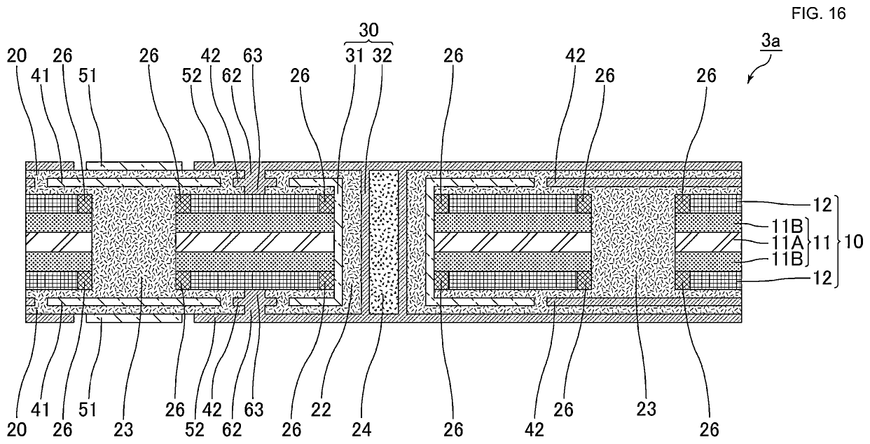

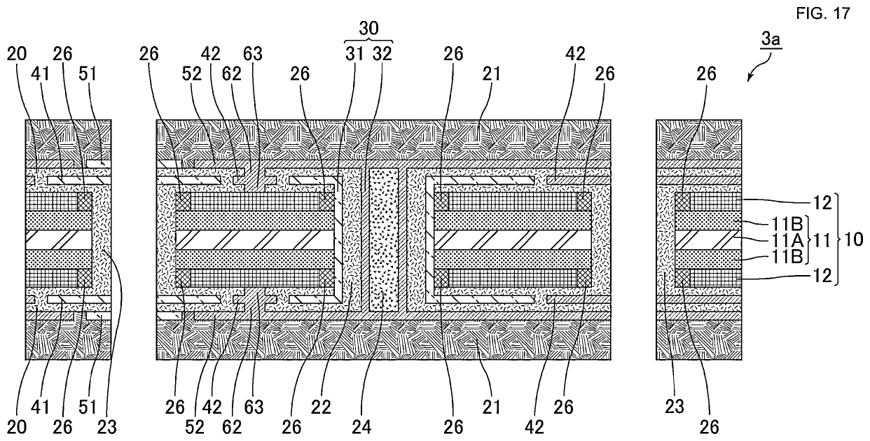

FIG. 16 is a diagram for explaining a method of manufacturing the capacitor illustrated in FIG. 13, and is a sectional view schematically illustrating the capacitor at a stage before sealing with an outer sealing layer. FIG. 17 is another diagram for explaining the method of manufacturing the capacitor illustrated in FIG. 13, and is a sectional view schematically illustrating the capacitor at a stage in which a through-hole is formed in the outer sealing layer.

The capacitor 3 is formed as follows, for example.

First, as illustrated in FIG. 16, a capacitor 3a at a stage before the outer sealing layer 21 is formed is prepared, as in the capacitor 1 illustrated in FIG. 1. In the capacitor 3a, the first through-hole for the first through-hole conductor 31 is formed, and a third through-hole for the third through-hole conductor and a fourth through-hole for the fourth through-hole conductor are formed. The third through-hole and the fourth through-hole are filled with the insulating material 23, and thereafter, the first through-hole conductor 31, the inner wiring layers 41 and 42, the second through-hole conductor 32, and the outer wiring layers 51 and 52 are formed in this order, as in the capacitor 1 illustrated in FIG. 1.

Next, as illustrated in FIG. 17, the capacitor 3a is sealed with the outer sealing layer 21. The capacitor 3a may be embedded in a substrate of a semiconductor package. Drilling, laser processing, or the like is performed on portions where the third through-hole conductor 33 and the fourth through-hole conductor 34 are to be formed, thereby forming through-holes, respectively.

The inner wall surfaces of the through-holes are metallized with a low-resistance metal such as copper, gold, or silver, thereby forming the third through-hole conductor 33 and the fourth through-hole conductor 34, respectively, as illustrated in FIG. 13. When the third through-hole conductor 33 and the fourth through-hole conductor 34 are formed, for example, metallizing the inner wall surface of the through-hole by electroless copper plating, electrolytic copper plating, or the like makes processing be easier.

The capacitor of the present disclosure may suitably be used as a constituent material of a composite electronic component. The composite electronic component includes, for example, the capacitor of the present disclosure, outer electrodes (for example, outer wiring layers) provided outside the sealing layer of the capacitor and electrically coupled to the first electrode layer and the second electrode layer of the capacitor respectively, and an electronic component coupled to the outer electrodes.

In the composite electronic component, the electronic component coupled to the outer electrode may be a passive element or an active element. Both of a passive element and an active element may be coupled to the outer electrode, or either one of a passive element or an active element may be coupled to the outer electrode. Alternatively, a composite body of a passive element and an active element may be coupled to the outer electrode.

Examples of the passive element include an inductor. Examples of the active element include a memory, a graphical processing unit (GPU), a central processing unit (CPU), a micro processing unit (MPU), and a power management IC (PMIC).

The capacitor of the present disclosure has a sheet-like shape as a whole. In the composite electronic component, therefore, the capacitor may be handled as a mounting substrate, and an electronic component may be mounted on the capacitor. Furthermore, by forming electronic components mounted on the capacitor in a sheet shape, the capacitor and the electronic components may be coupled in the thickness direction via a through-hole conductor penetrating through each electronic component in the thickness direction. As a result, the active element and the passive element may be configured as a collective module.

For example, a switching regulator may be formed by electrically coupling the capacitor of the present disclosure between a voltage regulator including a semiconductor active element and a load to which a converted DC voltage is supplied.

In a composite electronic component, a circuit layer may be formed on one surface of a capacitor matrix sheet on which the plurality of capacitors of the present disclosure are further laid out, and the circuit layer may be coupled to a passive element or an active element.

Alternatively, the capacitor of the present disclosure may be disposed in a cavity portion in a substrate provided in advance, and the capacitor may be embedded with a resin. Thereafter a circuit layer may be formed on the resin. Another electronic component (passive element or active element) may be mounted in another cavity portion of the same substrate.

Alternatively, the capacitor of the present disclosure may be mounted on a smooth carrier such as a wafer or glass, an outer layer portion may be formed of a resin, and then a circuit layer may be formed. Thereafter the circuit layer may be coupled to a passive element or an active element.

The present description discloses the following contents.

<1> A capacitor, comprising: a capacitor layer including a first electrode layer and a second electrode layer facing each other in a thickness direction with a dielectric layer interposed therebetween; and a coaxial through-hole conductor penetrating through the capacitor layer in the thickness direction, wherein the coaxial through-hole conductor includes: a first through-hole conductor electrically coupled to an end surface of the first electrode layer; and a second through-hole conductor inside the first through-hole conductor and electrically coupled to the second electrode layer, wherein the first through-hole conductor and the second through-hole conductor are insulated from each other.

<2> The capacitor according to <1>, further comprising a sealing layer that seals the capacitor layer.

<3> The capacitor according to <2>, further comprising an inner wiring layer inside the sealing layer, wherein the first electrode layer is electrically extended to a surface of the sealing layer via the first through-hole conductor and the inner wiring layer.

<4> The capacitor according to <2> or <3>, wherein the second through-hole conductor penetrates through both the capacitor layer and the sealing layer in the thickness direction of the capacitor layer.

<5> The capacitor according to any one of <1> to <4>, further comprising an insulating layer around the first through-hole conductor.

<6> The capacitor according to any one of <1> to <5>, wherein the first electrode layer is an anode plate including a core portion made of a metal and a porous portion on at least one main surface of the core portion, the dielectric layer is on a surface of the porous portion, and the second electrode layer is a cathode layer on a surface of the dielectric layer.

<7> The capacitor according to <6>, wherein the cathode layer includes a solid electrolyte layer on the surface of the dielectric layer.

<8> The capacitor according to any one of <1> to <7>, wherein the capacitor layer has two or more capacitance effective portions and an insulation partitioning portion that partitions the capacitance effective portions when viewed from the thickness direction.

<9> The capacitor according to <8>, wherein at least one of the coaxial through-hole conductor is inside the capacitance effective portion.

<10> The capacitor according to any one of <1> to <9>, wherein a width of the first through-hole conductor is smaller than a width of the second through-hole conductor.

### REFERENCE SIGNS LIST

1, 1a, 2, 3, 3a CAPACITOR
10 CAPACITOR LAYER
11 ANODE PLATE (FIRST ELECTRODE LAYER)
11A CORE PORTION
11B POROUS PORTION
12 CATHODE LAYER (SECOND ELECTRODE LAYER)
12A SOLID ELECTROLYTE LAYER
12B CONDUCTOR LAYER
12Ba CARBON LAYER
12Bb COPPER LAYER
13 DIELECTRIC LAYER
20 SEALING LAYER
21 OUTER SEALING LAYER
22, 23 INSULATING MATERIAL
24, 25 RESIN FILLING PORTION
26, 28 INSULATING LAYER
30 COAXIAL THROUGH-HOLE CONDUCTOR
31 FIRST THROUGH-HOLE CONDUCTOR
32 SECOND THROUGH-HOLE CONDUCTOR
33 THIRD THROUGH-HOLE CONDUCTOR
34 FOURTH THROUGH-HOLE CONDUCTOR
41, 42 INNER WIRING LAYER
51, 52, 71, 72 OUTER WIRING LAYER
61, 62, 63 VIA CONDUCTOR
AR1 CAPACITANCE EFFECTIVE PORTION
AR2 INSULATION PARTITIONING PORTION
d₂₂ DIAMETER Of INSULATING MATERIAL
d₂₆ DIAMETER Of INSULATING LAYER
d₃₁ DIAMETER OF FIRST THROUGH-HOLE CONDUCTOR
d₃₂ DIAMETER OF SECOND THROUGH-HOLE CONDUCTOR
w₃₁ WIDTH OF FIRST THROUGH-HOLE CONDUCTOR
w₃₂ WIDTH OF SECOND THROUGH-HOLE CONDUCTOR

1. A capacitor, comprising:
a capacitor layer including a first electrode layer and a second electrode layer facing each other in a thickness direction with a dielectric layer interposed therebetween; and
a coaxial through-hole conductor penetrating through the capacitor layer in the thickness direction, wherein the coaxial through-hole conductor includes:
a first through-hole conductor electrically coupled to an end surface of the first electrode layer; and
a second through-hole conductor inside the first through-hole conductor and electrically coupled to the second electrode layer,
wherein the first through-hole conductor and the second through-hole conductor are insulated from each other.

2. The capacitor according to claim 1, further comprising a sealing layer that seals the capacitor layer.

3. The capacitor according to claim 2, further comprising an inner wiring layer inside the sealing layer, wherein the first electrode layer is electrically extended to a surface of the sealing layer via the first through-hole conductor and the inner wiring layer.

4. The capacitor according to claim 3, wherein the second through-hole conductor penetrates through both the capacitor layer and the sealing layer in the thickness direction.

5. The capacitor according to claim 2, wherein the second through-hole conductor penetrates through both the capacitor layer and the sealing layer in the thickness direction.

6. The capacitor according to claim 1, further comprising an insulating layer around the first through-hole conductor.

7. The capacitor according to claim 1,
wherein the first electrode layer is an anode plate including a core portion made of a metal and a porous portion on at least one main surface of the core portion,
the dielectric layer is on a surface of the porous portion, and
the second electrode layer is a cathode layer on a surface of the dielectric layer.

8. The capacitor according to claim 7, wherein the cathode layer includes a solid electrolyte layer on the surface of the dielectric layer.

9. The capacitor according to claim 1, wherein the capacitor layer has two or more capacitance effective portions and an insulation partitioning portion that partitions the capacitance effective portions when viewed from the thickness direction.

10. The capacitor according to claim 9, wherein at least one of the coaxial through-hole conductor is inside the capacitance effective portion.

11. The capacitor according to claim 1, wherein a width of the first through-hole conductor is smaller than a width of the second through-hole conductor.

12. The capacitor according to claim 1, wherein a space between the first through-hole conductor and the second through-hole conductor is filled with an insulating material.

13. The capacitor according to claim 1, wherein an axis of the second through-hole conductor coincides with an axis of the first through-hole conductor.

14. The capacitor according to claim 1, wherein an inside of the second through-hole conductor is filled with a material containing a resin.
